(19) United States
(12) Patent Application Publication
(10) Pub. No.: US 2006/0062170 A1
(43) Pub. Date: Mar. 23, 2006

(54) Switch with a composite ethernet frame generator for use in a time division multiplex communications network

(75) Inventor: Xavier Boutaud De La Combe, Trebeurders (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/226,347

(22) Filed: Sep. 15, 2005

(30) Foreign Application Priority Data
Sep. 17, 2004 (FR) 04 52 089

(51) Int. Cl. H04B 7/212

(52) U.S. Cl. 370/321

(57) ABSTRACT

A switch (SW) for a time division multiplex communications network comprises line boards (LBi) each having a switching interface (SI) connected to TDM links (TL) for switching TDM frames of a selected type including time division multiplexed time slots and each associated with a TDM transmission channel. Each switching interface (SI) includes processing means (PM) for grouping time slots contained in the TDM frames received over at least one of its TDM links (TL) and including the designation of the same destination port and then integrating them into a composite Ethernet frame at selected positions of a portion dedicated to “payload” data and addressed to their destination port. The switch comprises Ethernet frame switching means (ES) connected to the various line boards (LBi) for switching the composite Ethernet frames to the line boards (LBi) as a function of their respective destination ports.

The invention relates to time division multiplex (TDM) communications networks and more particularly to switching TDM channels within such networks, regardless of what they are transporting.

As the person skilled in the art is aware, in a TDM network, voice (or data packets) to be transmitted is (or are) integrated into TDM frames, for example of the “E1” type, including time division multiplexed time slots each corresponding to a TDM logical channel.

To reach their destination, the TDM channels are usually switched in time switching matrices, known as TDM switches or time slot assigners, of certain switches of the network.

One switching option is to use layer 2 packet switches to switch the TDM channels. At least two such solutions have been proposed.

A first of those solutions is described in particular in the documentation of the IETF working group PWE3 and consists in transporting aggregates of channels instead of individual channels by emulating Ethernet TDM aggregates or circuits (for example n×64 kbit/s channels, with n>1). It has the drawback that it does not guarantee the transfer time within the switches. Furthermore, it is intended for transporting aggregates rather than for switching TDM channels, and therefore calls.

A second of the solutions referred to above is proposed by Alcatel and integrated into certain of its E10 fixed telephone exchanges, and consists in encapsulating TDM frames in ATM composite cells. It has the drawback that it does not allow the cells or packets of data to vary in length. Furthermore, it cannot be used in Ethernet switches since it is based on an ATM cross-connect unit (switch).

An object of the invention is to improve on the situation of there being no prior art solution that is entirely satisfactory, and in particular to provide a data packet transfer time that is substantially guaranteed, and if possible short.

To this end the invention proposes a switch for a time division multiplex communications network, the switch comprising at least one line board having a switching interface adapted to be connected to at least one TDM link for switching TDM frames of a selected type, e.g. E1 or T1 or even J1 including time division multiplexed time slots and each associated with a TDM transmission channel.

This switch is characterized by the facts that firstly each switching interface includes processing means for grouping time slots (or TDM channels) contained in TDM frames received over at least one of its TDM links and including the designation of the same destination port, and then integrating them into a composite Ethernet frame at selected positions of a portion dedicated to “payload” data and addressed to their destination port, and secondly the switch comprises Ethernet frame switching means connected to each line board for switching the composite Ethernet frames to at least one of the line boards LBi as a function of their respective destination ports.

In other words, the invention proposes to use a layer 2 Ethernet switch to switch TDM channels.

According to another feature of the invention, on receiving a composite Ethernet frame, the processing means extract the time slots that it contains in its payload data portion, preserving their respective positions, then determines the real (or original) positions of the extracted time slots within the TDM frames as a function of their respective positions, and reconstitutes TDM frames from the time slots and their real positions.

The switch of the invention may have other features, and in particular, separately or in combination:

a memory which stores a table of the correspondences between the time slots, their positions within the composite Ethernet frames and their real positions within the TDM frames. Under such circumstances, the processing means access the memory to determine the positions of the extracted time slots to be integrated into composite Ethernet frames and to determine the real positions of the time slots extracted from a received composite Ethernet frame. Each switching interface preferably comprises a memory storing the table of correspondences, which is preferably supplied by control means,

its processing means may be adapted to associate a transmission priority level with at least some of the composite Ethernet frames so that the Ethernet frame switching means send the composite Ethernet frames that they receive to the line board concerned in a time order that is a function of their respective priority levels,

if its processing means are adapted to switch non-composite Ethernet frames, they may assign composite Ethernet frames a priority higher than that associated with the other frames to guarantee them a minimum transfer time,

its processing means may constitute composite Ethernet frames of fixed or variable length,
in the variable length situation, the processing means truncate a composite Ethernet frame after the position associated with its last active time slot, for example, preferably if the length of that frame is greater than a selected number of bytes. The processing means may instead associate with the composite Ethernet frames information data representing their length and the positions of the time slots that they contain. Under such circumstances, the processing means may integrate the information data into the payload data portion of the composite Ethernet frames in the form of a header, for example. Furthermore, on receiving a composite Ethernet frame, the processing means may determine the real positions of the extracted time slots as a function of their respective positions and the information data,

its processing means may be adapted to control a mechanism for synchronizing the line boards with each other by distributing a clock, for example an 8 kHz clock, via the Ethernet switching means. For example, this mechanism may perform timing recovery by means of receivers of the line boards (the receivers reconstruct the send clock on the basis of synchronization information sent via the Ethernet frame switching means or integrated into the composite Ethernet frames and/or transported in non-composite Ethernet frames) and/or broadcast timing over dedicated links between the line boards (which do not necessarily pass through the Ethernet frame switching means).

Other features and advantages of the invention will become apparent on reading the following detailed description and examining the appended drawings, in which:

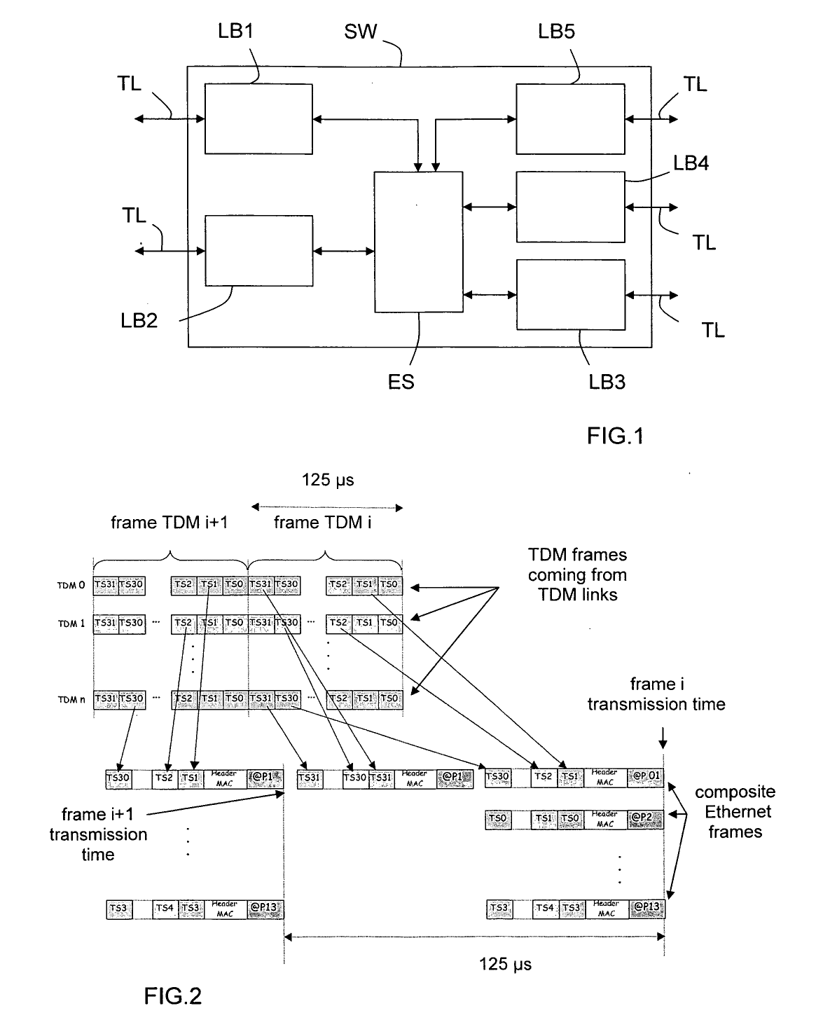

FIG. 1 is a diagram of an embodiment of a switch of the invention,

FIG. 2 is a diagram showing an example of the generation of composite Ethernet frames in accordance with the invention from TDM frames, and

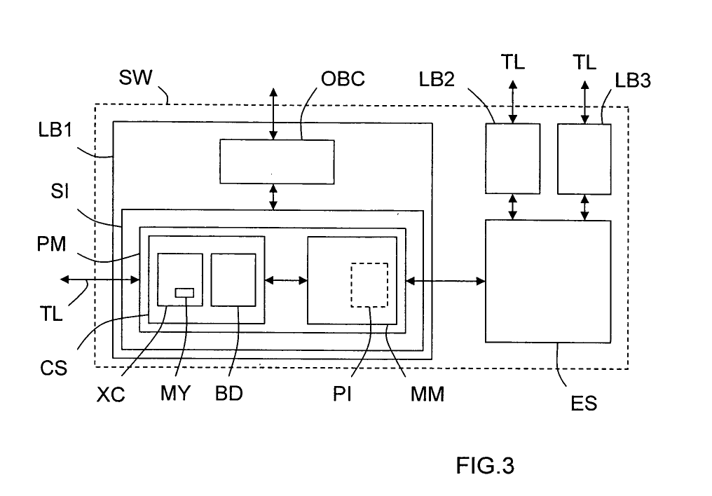

FIG. 3 is a diagram of an embodiment of a line board installed in a switch of the invention.

The appended drawings constitute part of the description of the invention and may, if necessary, contribute to the definition of the invention.

A switch SW of the invention intended for use in a TDM communications network is described first with reference to FIG. 1.

A switch SW of this kind comprises at least one line board LBi connected to at least one TDM link TL, and generally to a plurality of such links, and to a common Ethernet switching module ES. In the non-limiting example shown here, the switch SW comprises five line boards LBi (i=1 to 5), but it could have any other number of line boards (it must have either at least two boards supporting one or more TDM links or at least one board supporting at least two TDM links).

Each TDM link TL allows the line board LBi concerned to exchange TDM frames of a selected type, including time division multiplexed time slots each associated with a TDM logic channel, with other equipment (where applicable with a router or with another switch).

E1 type TDM frames are considered hereinafter by way of non-limiting example, but the frames could be of some other type, for example T1 or J1 type frames.

For example, an E1 type TDM frame generally comprises 32 time slots each associated with one 64 kbit/s channel and each corresponding to one byte. The E1 type frames are sent every 125 μs (which corresponds to a frequency of 8 kHz). A T1 type frame comprises 24 time slots and is also sent every 125 μs.

Each line board LBi comprises at least one switching interface SI for switching each TDM frame received on one of the TDM links TL to another line board LBi′ designated by the identifier of the destination port that it contains via the Ethernet switching module ES, as emerges below.

According to the invention, each switching interface SI comprises a processing module PM for grouping time slots (or TDM channels) contained in TDM frames received over at least one of its TDM links TL and including the designation of the same destination port, and then integrating them into a composite Ethernet frame (i.e. into the same data packet), at selected positions in the payload and addressed to their destination port.

A composite Ethernet frame therefore includes time slots (or TDM channels) that all belong to the same time period of 125 μs and come from one or more TDM links. FIG. 2 shows an example of the generation of composite Ethernet frames in accordance with the invention from TDM frames coming from different links. In this example, the rectangles TSj (j=0 to 31) represent the time slots, the “MAC header” rectangles represent the MAC header fields, and the “@Pk” rectangles (in this example k=1 to 13) represent the Ethernet address of the destination board (i.e. its destination ports). The “destination Ethernet address” field is in reality part of the Ethernet frame header (or “MAC header”), in contrast to what is shown diagrammatically in the figure.

To group the TDM frames (here E1 type frames) as a function of their destination ports, the processing module PM may include, for example, as shown in FIG. 3, a composite stage CS divided into a connection module (or matrix) XC for extracting the time slots (or TDM channels) having the same destination port from the TDM frames and putting them in order and a builder/debuilder module BD for generating streams of time slots (or TDM channels) in order from the extracted time slots.

The time slots extracted from the TDM frames may be ordered in a “direct” fashion as a function of their order in the TDM frames received. This is not mandatory, however. For example, if the time slots (or TDM channels) are not ordered in this direct fashion they can be ordered by accessing a memory MY which stores a table of the correspondences between the various time slots (associated with the various TDM logical channels), their selected positions within the composite Ethernet frames, and their actual positions within the TDM frames. For example, each processing module PM includes its own memory MY which it can scan in 125 μs by comparing the time slot (TS) numbers of the extracted time slots with those stored in the table. This memory MY may form part of the composite stage CS, for example part of its connection module XC.

Each line board LBi preferably includes an onboard controller module OBC coupled to the communications network for supplying the table of correspondences to the memory MY of the processing module PM of the switching interface SI with which it is associated. For example, this table is updated periodically and/or after each modification. For example, the OBC module is a microcontroller for physically monitoring the switching interface SI and in particular for managing alarms. It is supervised by a monitoring board installed in the switch SW, for example.

Moreover, to integrate time slots (or TDM channels) grouped in composite Ethernet frames, the processing module PM may include, for example, a medium access control (MAC) module (or component) MM coupled to the composite stage CS, to be more precise to its builder/debuilder module BD. This MAC module produces the composite Ethernet frames by integrating in their payload field the extracted and ordered time slots that belong to the same stream, which are supplied by the builder/debuilder module BD and the number whereof is preferably from 46 to 1 500.

It must be remembered that an Ethernet frame, for example a VLAN marking frame, generally comprises a destination port MAC field defined by 6 bytes, a source port MAC field defined by 6 bytes, a tag protocol identifier (TPID) field defined by 2 bytes, a tag control information (TCI) field defined by 2 bytes and including in particular a user priority (UP) sub-field and a VLAN identifier (VID) sub-field, a TYPE LONG field defined by 2 bytes, a payload field, and a frame checksum (FCS) field defined by 4 bytes.

Thanks to this way of inserting time slots into the payload field, the standard Ethernet frame is not modified and the MAC module (or component) MM, which constitutes a portion of the processing module PM, can be of a standard type and requires no adaptation.

Each composite Ethernet frame includes in its payload field an ordered series of time slots (or TDM channels) supplied by the processing module PM and then communicated to a physical interface PI in order to be sent to the Ethernet frame switching module ES in order to be switched therein to the line board LBi corresponding to the destination port designated in its destination port field.

It is important to note that the invention allows the generation of fixed or variable length composite Ethernet frames.

With fixed length composite Ethernet frames, all the composite Ethernet frames have the same length. On reception, each TDM channel (or time slot) of a composite Ethernet frame is then identified as a function of its position within the payload field, where applicable by consulting the table of correspondences. This simplifies generating composite Ethernet frames and reconstituting the initial TDM frames. However, certain positions of the payload field may be associated with time slots with no data (known as “inactive” time slots), with the result that a portion of the bandwidth is used to no benefit.

Variable length composite Ethernet frames are intended to remedy the drawbacks of fixed length composite Ethernet frames. At least two embodiments of the processing module PM, to be more precise the composite stage CS thereof, may then be envisaged.

In a first embodiment, the processing module PM truncates each composite Ethernet frame after the position that is associated with its last active time slot (“active” in the sense that it is associated with data). It is then preferable for the truncation to be applied only after a position whereby the length of the composite Ethernet frame is greater than a selected number of bytes, for example 64 bytes. It is preferably the builder/debuilder module BD that performs this truncation.

In a second embodiment, the processing module PM associates with each composite Ethernet frame information data that represents its length (to be more precise the number of active time slots transported) and the positions of the active time slots that it contains in its payload field. To this end, the processing module PM, or to be more precise its composite stage CS, may integrate the information data at a selected location of the payload field of the composite Ethernet frame, for example. This can take the form of a header occupying the first positions of the payload field, for example. On reception, the TDM frames are then reconstituted as a function of the respective positions of the time slots (or TDM channels) contained in the payload field and the information data contained in the header of the payload field.

The processing module PM, and preferably its composite stage CS, may associate a transmission priority level with at least some composite Ethernet frames, for example at the request of the onboard controller module OBC. For example, if the priority level concerns layer 2, it may be defined in the user priority (UP) subfield of the tag control identifier (TCI) field in accordance with the IEEE 802.1p standard. Of course, other types of priority may be envisaged.

When the Ethernet frame switching module ES receives composite Ethernet frames containing priority levels, it classifies them as a function of those priority levels in order to send them to the line boards LBi concerned one after the other in the time order defined by the classification.

Accordingly, for frames containing the highest priority level, the transfer time in the switch SW can be guaranteed to be substantially constant and less than or equal to n×125 μs, with 2≦n≦10.

If the processing module PM switches Ethernet frames other than composite Ethernet frames, it may assign composite Ethernet frames a higher priority than other frames, in order to guarantee them a minimum transfer time.

When a composite Ethernet frame reaches a line board LBi′ after it has been switched by the Ethernet switching module ES, it is taken up by its processing module PM. To be more precise, the processing module PM begins by extracting the time slots that are contained in its payload field, preserving their respective positions. It then determines their original (or real) positions within the TDM frames as a function of their respective positions within the composite Ethernet frame received, for example by consulting the table of correspondences. Finally, it reconstitutes the TDM frames from the time slots extracted and their real positions.

For example, the MAC module MM extracts the bytes of the payload field from the composite Ethernet frames sent successively over the physical interface PI, preserving their respective orders, after which the builder/debuilder module BD of the composite stage CS builds a stream of bytes from the extracted bytes, still preserving the original order. To this end, it consults the table of correspondences stored in the memory MY (if present), in order to scan it in 125 μs by comparing the TS numbers of the extracted time slots (or bytes) to those stored in the table.

The connection module XC of the composite stage CS then stores the bytes of the streams received in TDM frames as a function of their respective positions.

The processing module PM may also monitor a mechanism for distributing a clock, for example an 8 kHz clock, via the Ethernet switching module ES. This mechanism synchronizes the line boards LBi with each other. For example, it may perform timing recovery by means of the receivers of the line boards LBi. To be more precise, the receivers reconstruct the send clock from synchronization information that is transmitted through the Ethernet switching module ES or integrated into the composite Ethernet frames and/or transported in non-composite Ethernet frames. The mechanism may equally, instead or additionally, broadcast the timing over the dedicated synchronization links between the line boards LBi (which links do not necessary pass through the Ethernet switching module ES).

The switch SW according to the invention, and in particular its processing module PM, may take the form of electronic circuits, software (or data processing) modules, or a combination of circuits and software.

Thanks to the invention, composite Ethernet frames can transport and switch TDM channels, for example 64 kbit/s channels, without losing temporal continuity (for example a sample every 125 μs) and with a substantially constant transfer time (n×125 μs, with 2≦n≦10) in the Ethernet switching module (or switch). This avoids the need to use an echo canceller in the transport chain, which is especially beneficial from the economic point of view in particular.

The invention is not limited to the switch embodiments described hereinabove by way of example only, and encompasses all variants that the person skilled in the art might envisage that fall within the scope of the following claims.

1. A switch (SW) for a time division multiplex (TDM) communications network, said switch (SW) comprising at least one line board (LBi) having a switching interface (SI) adapted to be connected to at least one TDM link (TL) for switching TDM frames of a selected type including time division multiplexed time slots and each associated with a TDM transmission channel, characterized in that each switching interface (SI) includes processing means (PM) adapted:
to group time slots contained in TDM frames received over at least one of its TDM links (TL) and including the designation of the same destination port; and
then to integrate them into a composite Ethernet frame at selected positions of a portion dedicated to “payload” data and addressed to their destination port,
and in that the switch comprises Ethernet frame switching means (ES) connected to each line board for switching the composite Ethernet frames to at least one of the line boards (LBi) as a function of their respective destination ports.

2. A switch according to claim 1, characterized in that, on receiving a composite Ethernet frame, said processing means (PM) are adapted:
to extract the time slots that it contains in its payload data portion, preserving their respective positions, then
to determine the real positions of said extracted time slots within said TDM frames as a function of their respective positions, and
to reconstitute TDM frames from said time slots and their real positions.

3. A switch according to claim 1, characterized in that it comprises a memory (MY) which stores a table of the correspondences between said time slots, their positions within the composite Ethernet frames and their real positions within the TDM frames, and
in that said processing means (PM) access said memory (MY) to determine the positions of the extracted time slots to be integrated into composite Ethernet frames and to determine the real positions of the time slots extracted from a received composite Ethernet frame.

4. A switch according to claim 3, characterized in that each switching interface (SI) comprises a memory (MY) storing said table of correspondences.

5. A switch according to claim 4, characterized in that each line board (LBi) comprises control means (OBC) adapted to supply said table of correspondences to the memory (MY) of the associated switching interface (SI).

6. A switch according to claim 1, characterized in that said processing means (PM) are adapted to associate a transmission priority level with at least some of said composite Ethernet frames so that said Ethernet frame switching means (ES) send the composite Ethernet frames that they receive to the line board (LBi) concerned in a time order that is a function of their respective priority levels.

7. A switch according to claim 6, characterized in that said processing means (PM) are adapted to switch non-composite Ethernet frames and to assign composite Ethernet frames a priority higher than that associated with non-composite Ethernet frames to guarantee said composite Ethernet frames a minimum transfer time.

8. A switch according to claim 1, characterized in that said processing means (PM) are adapted to constitute composite Ethernet frames of fixed length.

9. A switch according to claim 1, characterized in that said processing means (PM) are adapted to constitute composite Ethernet frames of variable length.

10. A switch according to claim 9, characterized in that said processing means (PM) are adapted to truncate a composite Ethernet frame after the position associated with its last active time slot.

11. A switch according to claim 10, characterized in that said processing means (PM) are adapted to truncate said composite Ethernet frame if its length is greater than a selected number of bytes.

12. A switch according to claim 9, characterized in that said processing means (PM) are adapted to associate with said composite Ethernet frames information data representing their length and the positions of the time slots that they contain.

13. A switch according to claim 12, characterized in that said processing means (PM) are adapted to integrate said information data into the payload data portion of the composite Ethernet frames in the form of a header.

14. A switch according to claim 12, characterized in that said processing means (PM) are adapted, on receiving a composite Ethernet frame, to determine the real positions of said extracted time slots as a function of their respective positions and said information data.

15. A switch according to claim 1, characterized in that said processing means (PM) are adapted to control a mechanism for synchronizing said line boards (LBi) with each other by distributing a clock via said Ethernet frame switching means (ES).

16. A switch according to claim 15, characterized in that said processing means (PM) are adapted to perform timing recovery by means of receivers of said line boards (LBi).

17. A switch according to either claim 15 or claim 16, characterized in that said processing means (PM) are adapted to broadcast timing over dedicated links between said line boards (LBi).
